(19) United States
(12) Patent Application Publication
(10) Pub. No.: US 2026/0100623 A1
(43) Pub. Date: Apr. 9, 2026

(54) BRUSHLESS MOTOR

(71) Applicant: Orbray Co., Ltd., Tokyo (JP)

(72) Inventor: Kouji OKI, Tokyo (JP)

(21) Appl. No.: 19/340,946

(22) Filed: Sep. 26, 2025

(30) Foreign Application Priority Data
Oct. 3, 2024 (JP) 2024-173956

(51) Int. Cl. H02K 11/215; H02K 21/20

(52) U.S. Cl. CPC H02K 11/215; H02K 21/20; H02K 2211/03

(57) ABSTRACT

In a brushless motor, a coil cap is formed with a cap-side first positioner in which a coil-side positioner is to be fitted and a cap-side second positioner for positioning Hall elements of a plurality of phases about an axis with respect to the coil cap. A circuit board is formed with a board-side positioner in which the cap-side second positioner is to be fitted. A relative positional relationship about the axis between the cap-side first positioner and the cap-side second positioner is such a positional relationship that the Hall elements of the plurality of phases are positioned at preset positions about the axis relative to stator coils of a plurality of phases.

### CROSS-REFERENCE TO RELATED APPLICATION

This application is based on Japanese Patent Application No. 2024-173956 filed with the Japan Patent Office on Oct. 3, 2024, the entire content of which is hereby incorporated by reference.

### BACKGROUND

### 1. Technical Field

One aspect of the present disclosure relates to a brushless motor.

### 2. Related Art

Conventionally, in an inner rotor magnet type brushless motor, Hall elements of a plurality of phases detect rotation of a rotor magnet, and based on such a detection result, timing of reversing the polarity of an alternating magnetic field generated by stator coils of a plurality of phases is determined (for example, see JP-A-2003-333818). In such a brushless motor, the Hall elements of the plurality of phases are positioned at positions about an axis, which are optimal for determining the timing of reversing the polarity, with respect to the stator coils of the plurality of phases.

### SUMMARY

A brushless motor including: a shaft; a rotor magnet coupled to the shaft; stator coils of a plurality of phases arranged so as to surround the rotor magnet about an axis and rotating the rotor magnet; a coil cover formed in a cylindrical shape housing the rotor magnet therein and holding the stator coils of the plurality of phases on an outer peripheral side; a circuit board disposed on one end side of the coil cover and configured to detect rotation of the rotor magnet by Hall elements of a plurality of phases mounted and arranged about the axis; and a coil cap disposed between a board-side cover edge of the coil cover and the circuit board and holding the circuit board, in which the cover edge is formed with a coil-side positioner for positioning the coil cap about the axis with respect to the stator coils of the plurality of phases, the coil cap is formed with a cap-side first positioner in which the coil-side positioner is to be fitted, the coil cap is formed with a cap-side second positioner for positioning the Hall elements of the plurality of phases about the axis with respect to the coil cap, the circuit board is formed with a board-side positioner in which the cap-side second positioner is to be fitted, and a relative positional relationship about the axis between the cap-side first positioner and the cap-side second positioner is such a positional relationship that the Hall elements of the plurality of phases are positioned at preset positions about the axis relative to the stator coils of the plurality of phases.

### BRIEF DESCRIPTION OF DRAWINGS

FIG. 1 is a perspective view of a brushless motor according to one embodiment, and shows the internal structure thereof in a section cut along a shaft axis;

FIG. 2 is a sectional view showing the section of the brushless motor of FIG. 1 taken along V11-V11 line in FIG. 1;

FIG. 3 is an exploded view showing the configuration of the brushless motor of FIG. 1 around a coil unit;

FIG. 4 is an exploded view showing the configurations of the coil unit, a coil cap, and a circuit board in the brushless motor of FIG. 1;

FIG. 5A is a perspective view showing the circuit board of FIGS. 1 and 4 from the back surface of a mount surface for mounting Hall elements, and FIG. 5B is a perspective view of the circuit board of FIGS. 1 and 4 from the mount surface side for mounting the Hall elements;

FIG. 6 is a view showing routing of coil electric wires from stator coils without the circuit board; and

FIG. 7 is a view showing the routing of the coil electric wires from the stator coils from the back surface of the mount surface, which is for mounting the Hall elements, of the circuit board.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Among the brushless motors for which the timing of reversing the polarity of the alternating magnetic field is determined based on the detection result obtained by the Hall elements, there is one configured such that the positions of the Hall elements are aligned with the stator coils while a board on which the Hall elements are mounted is moving about the axis at the time of manufacturing. Such position alignment makes a process itself difficult, which causes a burden on a worker.

For this reason, in view of the above-described situation, one object of the present disclosure is to provide the following brushless motor. According to the brushless motor, the burden on the worker can be reduced while the Hall elements are disposed at the positions optimal for determining the timing of reversing the polarity in the stator coils.

A brushless motor that includes: a shaft; a rotor magnet coupled to the shaft; stator coils of a plurality of phases arranged so as to surround the rotor magnet about an axis and rotating the rotor magnet; a coil cover formed in a cylindrical shape housing the rotor magnet therein and holding the stator coils of the plurality of phases on an outer peripheral side; a circuit board disposed on one end side of the coil cover and configured to detect rotation of the rotor magnet by Hall elements of a plurality of phases mounted and arranged about the axis; and a coil cap disposed between a board-side cover edge of the coil cover and the circuit board and holding the circuit board. In the brushless motor, the cover edge is formed with a coil-side positioner for positioning the coil cap about the axis with respect to the stator coils of the plurality of phases, the coil cap is formed with a cap-side first positioner in which the coil-side positioner is to be fitted, the coil cap is formed with a cap-side second positioner for positioning the Hall elements of the plurality of phases about the axis with respect to the coil cap, the circuit board is formed with a board-side positioner in which the cap-side second positioner is to be fitted, and a relative positional relationship about the axis between the cap-side first positioner and the cap-side second positioner is such a positional relationship that the Hall elements of the plurality of phases are positioned at preset positions about the axis relative to the stator coils of the plurality of phases.

According to the above-described brushless motor, the coil-side positioner is fitted in the cap-side first positioner, and in this manner, the coil cap is positioned with respect to the stator coils of the plurality of phases. Moreover, the cap-side second positioner is fitted in the board-side positioner, and in this manner, the Hall elements of the plurality of phases are positioned with respect to the coil cap. Further, the cap-side first positioner and the cap-side second positioner are formed in such a positional relationship that the Hall elements of the plurality of phases are positioned at the preset positions relative to the stator coils of the plurality of phases. That is, in the above-described brushless motor, the Hall elements of the plurality of phases are positioned at the preset positions relative to the stator coils of the plurality of phases only by two fitting processes. Moreover, these relative positions are designed to positions optimal for determining the timing of reversing the polarity in the stator coils, and in this manner, the Hall elements are disposed at the optimal positions only by the two fitting processes at the time of manufacturing. As described above, according to the brushless motor, the burden on the worker can be reduced while the Hall elements are disposed at the positions optimal for determining the timing of reversing the polarity in the stator coils.

Here, it is preferable that the coil-side positioner includes one coil-side positioner for each phase according to arrangement of the stator coils of the plurality of phases, the cap-side first positioner includes cap-side first positioners fitted in one-to-one correspondence with the plurality of coil-side positioners, the board-side positioner includes one board-side positioner for each phase according to arrangement of the Hall elements of the plurality of phases, and the cap-side second positioner includes cap-side second positioners fitted in one-to-one correspondence with the plurality of board-side positioners.

According to this configuration, the numbers of coil-side positioners, cap-side first positioners, cap-side second positioners, and board-side positioners are the same as the number of phases for the stator coils and the Hall elements. With this configuration, the worker can perform the fitting process while visually checking a state of the Hall elements of the plurality of phases being positioned with respect to the stator coils of the plurality of phases.

Further, it is more preferable that the plurality of coil-side positioners is provided about the axis at positions in one-to-one correspondence with centers of the stator coils of the plurality of phases or positions in one-to-one correspondence with boundaries between the stator coils of the plurality of phases, the plurality of board-side positioners is provided about the axis at positions in one-to-one correspondence with the Hall elements of the plurality of phases, and the plurality of cap-side first positioners and the plurality of cap-side second positioners are provided about the axis in one-to-one correspondence with each other.

The position of the Hall element optimal for determining the timing of reversing the polarity in the stator coil is, for example, the position corresponding to the center of the stator coil and the position corresponding to the boundary between the stator coils about the axis. According to the above-described configuration, the Hall elements are at these positions. Thus, the accuracy of positioning the Hall elements at the optimal positions by the above-described fitting process can be improved.

Further, it is preferable that the coil cap has a bottomed cylindrical shape with a greater diameter than that of the cover edge, and at a center of a bottom wall thereof, is provided with a cap center through-hole through which the shaft penetrates, the circuit board is a circular board having a greater diameter than a board-side inner diameter of the coil cap, and is held in a state of being mounted on a peripheral wall edge of the coil cap, the coil-side positioner is a piece protruding in an axial direction from the cover edge, the cap-side first positioner is a recessed cutout provided in an inner peripheral edge of the cap center through-hole such that the coil-side positioner is fitted therein, the cap-side second positioner is a piece protruding in the axial direction from the peripheral wall edge, and the board-side positioner is a recessed cutout provided in an outer peripheral edge of the circuit board such that the cap-side second positioner is fitted therein.

According to this configuration, the location of fitting between the coil-side positioner and the cap-side first positioner and the location of fitting between the cap-side second positioner and the board-side positioner are shifted from each other in the radial direction. With this configuration, interference between these locations can be avoided, and therefore, the worker can perform the fitting process with favorable workability.

Further, it is more preferable that a surface of the circuit board facing the coil cap is a mount surface for mounting the Hall elements of the plurality of phases, and a coil electric wire extending from each of the stator coils of the plurality of phases reaches a back surface side of the mount surface of the circuit board through the cap-side first positioner and the board-side positioner as the recessed cutouts, and is connected to a back surface of the mount surface.

According to this configuration, the cap-side first positioner and the board-side positioner as the recessed cutouts also serve as a coil electric wire routing path. With this configuration, the shapes of the coil cap and the circuit board can be simplified as compared to a case where a routing path different from the above-described positioners is formed, or the like.

Further, it is preferable that each of the stator coils of the plurality of phases is an α-winding coil.

According to the α-winding coil, the coil electric wire can extend from the coil outer peripheral side without overlapping with the coil. According to this configuration, as compared to coils of other winding types configured such that the coil electric wire extends from the coil inner peripheral side while overlapping with the coil, the coil electric wire can extend with a less dimension of the stator coil in the thickness direction thereof.

According to the above-described brushless motor, the burden on the worker can be reduced while the Hall elements are disposed at the positions optimal for determining the timing of reversing the polarity in the stator coils.

Hereinafter, one embodiment of the brushless motor will be described.

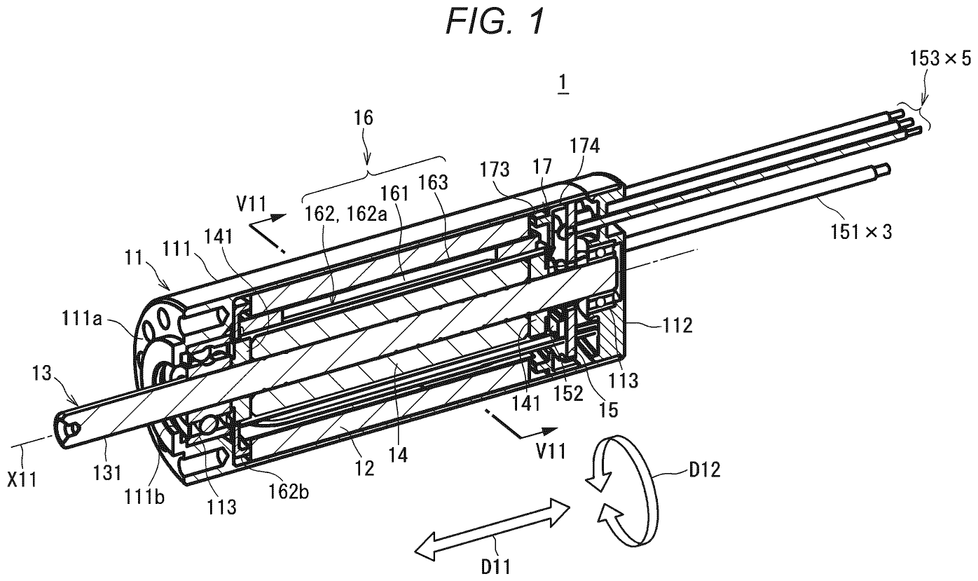

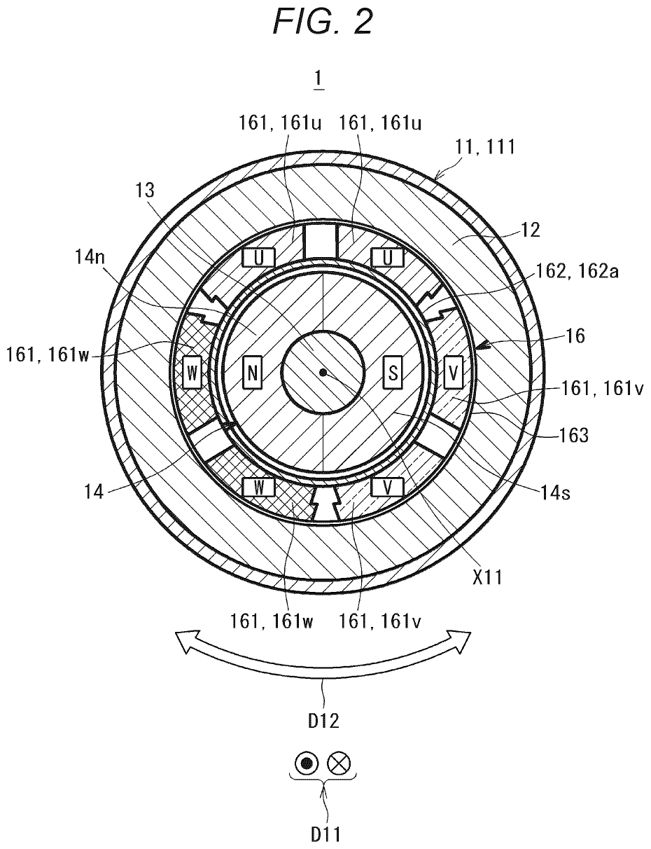

FIG. 1 is a perspective view of the brushless motor according to one embodiment, and shows the internal structure thereof in a section cut along a shaft axis. FIG. 2 is a sectional view showing the section of the brushless motor of FIG. 1 taken along V11-V11 line in FIG. 1.

The brushless motor 1 shown in FIG. 1 is an inner rotor magnet type motor having a brushless structure. The brushless motor 1 includes a motor case 11, a yoke 12, a shaft 13, a rotor magnet 14, a circuit board 15, and a coil unit 16.

The motor case 11 includes a bottomed cylindrical case body 111 and a case cover 112 closing an opening of the case body 111. Further, a pair of ball bearings 113 is provided inside a bottom wall portion 111a of the case body 111 on one end side in an axial direction D11 along an axis X11 and inside the case cover 112 on the other end side. The pair of ball bearings 113 pivotally supports the shaft 13 such that the shaft 13 is rotatable in a direction D12 about the axis X11. The center of the bottom wall portion 111a of the case body 111 is provided with an output port 111b through which an output end 131 of the shaft 13 protrudes.

The yoke 12 is a member formed in a cylindrical shape from a magnetic body and fixed and placed on the inner peripheral surface of the case body 111. The yoke 12 houses the coil unit 16 therein. The yoke 12 fulfills a role as a magnetic path of a magnetic field generated from the coil unit 16.

The shaft 13 is an output shaft of the motor, and as described above, is rotatably and pivotally supported by the motor case 11 through the pair of ball bearings 113.

The rotor magnet 14 is a cylindrical permanent magnet rotatable together with a pair of bush members 141 and the shaft 13. The shaft 13 penetrates the rotor magnet 14 in the axial direction D11, and both ends of the rotor magnet 14 are coupled to the shaft 13. In the present embodiment, the rotor magnet 14 is a magnet having a plurality of poles, specifically two poles which are an N-pole 14n and an S-pole 14s disposed in the direction D12 about the axis.

The circuit board 15 is disposed inside the case cover 112 in a state of an end portion of the shaft 13 penetrating the circuit board 15. The circuit board 15 is a printed circuit board for power distribution to the coil unit 16, detection of a rotation position, and the like. A motor electric wire 151 for the power distribution to the coil unit 16 is connected to the circuit board 15. Here, the brushless motor 1 of the present embodiment is a motor of three phases which are a U-phase, a V-phase, and a W-phase, and three motor electric wires 151, i.e., one motor electric wire 151 for each phase, are connected to the brushless motor 1. For the position detection, Hall elements 152 of a plurality of phases (specifically the three phases which are the U-phase, the V-phase, and the W-phase) are mounted on the circuit board 15. The total of five Hall element electric wires 153 including one output electric wire for each Hall element 152, an input electric wire, and a neutral point electric wire are connected to the circuit board 15. The motor electric wires 151 and the Hall element electric wires 153 extend to the outside of the motor through the case cover 112. The circuit board 15 will be described later again with reference to other figures.

The coil unit 16 is disposed between the yoke 12 and the rotor magnet 14 so as to surround the rotor magnet 14 in a cylindrical shape in the direction D12 about the axis. The circuit board 15 is disposed between a case cover 112-side end portion of the coil unit 16 and the case cover 112. A coil cap 17 for holding the circuit board 15 is disposed between the circuit board 15 and the coil unit 16.

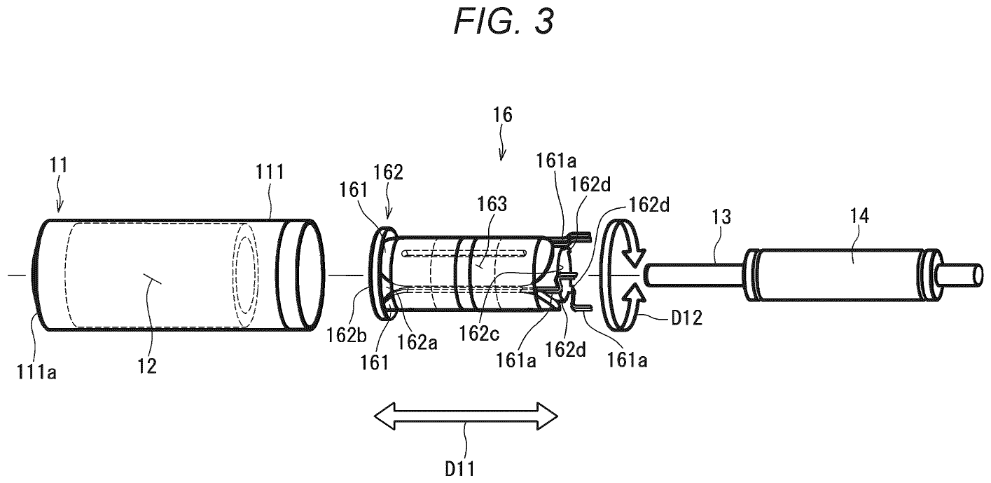

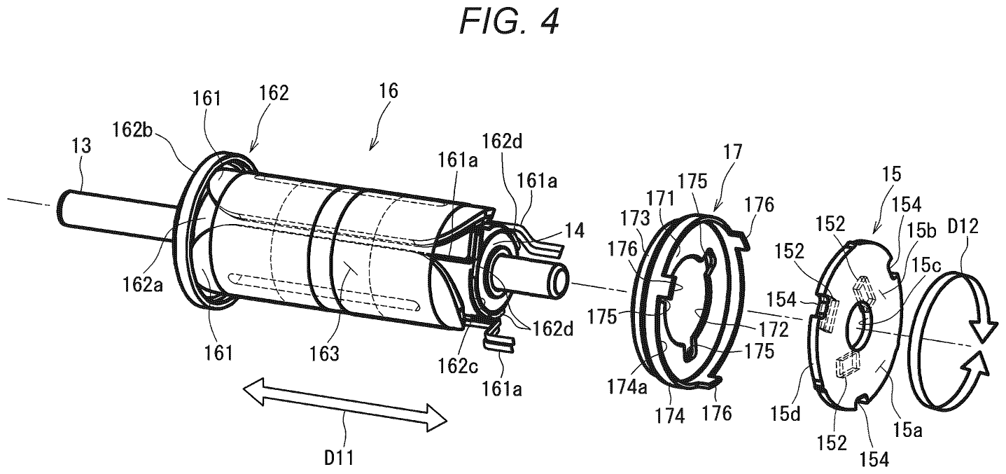

FIG. 3 is an exploded view showing the configuration of the brushless motor of FIG. 1 around the coil unit. FIG. 4 is an exploded view showing the configurations of the coil unit, the coil cap, and the circuit board in the brushless motor of FIG. 1.

As also shown in FIGS. 1 and 2, the coil unit 16 includes stator coils 161 of the three phases which are the U-phase, the V-phase, and the W-phase, a coil cover 162, and a coil fixing tape 163

The stator coils 161 of the three phases are arranged so as to surround the rotor magnet 14 coupled to the shaft 13 in the direction D12 about the axis. The stator coils 161 of the three phases are three coil members that generate an alternating magnetic field by power distribution to rotate the rotor magnet 14. Any of a U-phase coil 161u, a V-phase coil 161v, and a W-phase coil 161w forming the stator coils 161 of the three phases is an α-winding coil wound in an oval shape long in the axial direction D11. In each stator coil 161 as the α-winding coil, two coil electric wires 161a for power distribution and a neutral point extend from the coil outer peripheral side in the axial direction D11 without overlapping with the coil.

The coil cover 162 is made of resin, and includes a cover body 162a and a coil receiver 162b. The cover body 162a is formed in a cylindrical shape housing the rotor magnet 14 therein, and on the outer peripheral side thereof, holds the stator coils 161 of the three phases. The coil receiver 162b is formed in a flange shape integrally with the cover body 162a on the side close to the bottom wall portion 111a of the case body 111. The coil receiver 162b holds the stator coils 161 of the three phases on the bottom wall portion 111a side. Further, the coil receiver 162b is sandwiched between the yoke 12 and the bottom wall portion 111a in the case body 111 as shown in FIG. 1, and therefore, stabilizes the position of the coil unit 16 in the axial direction D11 in the case body 111.

The coil fixing tape 163 is, for example, a tape material made of Kapton (registered trademark). The coil fixing tape 163 is wound in the direction D12 about the axis from the further outside of the stator coils 161 of the three phases held on the outer peripheral side of the coil cover 162, and therefore, fixes the stator coils 161 of the three phases.

The above-described coil unit 16 houses therein the rotor magnet 14 equipped with the shaft 13, and is housed inside the motor case 11 equipped with the yoke 12. Further, the coil cap 17 and the circuit board 15 are attached to the side of the coil unit 16 opposite to the side on which the shaft 13 protrudes.

The coil cap 17 is a member made of resin, disposed between a board-side cover edge 162c of the coil cover 162 and the circuit board 15, and holding the circuit board 15. In the present embodiment, the coil cap 17 has a bottomed cylindrical shape with a greater diameter than that of the cover edge 162c. The center of a bottom wall 171 of the coil cap 17 is provided with a cap center through-hole 172 through which the shaft 13 penetrates. Further, the coil cap 17 is provided, on the coil unit 16 side, with a cylindrical protrusion 173.

The circuit board 15 is a circular board having a greater diameter than the board-side inner diameter of the coil cap 17. The circuit board 15 is held in a state of being mounted on a peripheral wall edge 174a of a board-side peripheral wall 174 of the coil cap 17. The surface of the circuit board 15 facing the coil cap 17 is a mount surface 15a for mounting the Hall elements 152 of the three phases. The coil electric wires 161a from each stator coil 161 are routed as described later, reach the back surface 15b side of the mount surface 15a, which is for mounting the Hall elements 152, of the circuit board 15, and are connected to the back surface 15b. The center of the circuit board 15 is formed with a shaft through-hole 15c through which the shaft 13 penetrates.

In the present embodiment, the Hall elements 152 mounted on the circuit board 15 are positioned with respect to the stator coils 161 of the coil unit 16 by the following configuration.

First, a plurality (specifically three) of coil-side positioners 162d is formed at the cover body 162a, i.e., the board-side cover edge 162c of the coil cover 162. The coil-side positioner 162d is a portion for positioning the coil cap 17 in the direction D12 about the axis with respect to the stator coils 161 of the three phases. One coil-side positioner 162d is provided for each phase according to the arrangement of the stator coils of the three phases. Moreover, these three coil-side positioners 162d are provided at positions in one-to-one correspondence with portions between the stator coils 161 of the three phases in the direction D12 about the axis. Each coil-side positioner 162d is a rectangular piece protruding in the axial direction D11 from the cover edge 162c.

The coil cap 17 is formed with cap-side first positioners 175 in which the coil-side positioners 162d of the coil cover 162 are to be fitted. Three cap-side first positioners 175 are provided such that the three coil-side positioners 162d are fitted therein in one-to-one correspondence. Each cap-side first positioner 175 is a rectangular recessed cutout provided in the inner peripheral edge of the cap center through-hole 172 of the bottom wall 171 such that the coil-side positioner 162d is fitted therein. The coil-side positioners 162d of the coil cover 162 are fitted in the cap-side first positioners 175 of the coil cap 17, and in this manner, the coil cap 17 is positioned in the direction D12 about the axis with respect to the stator coils 161 of the three phases.

Further, the coil cap 17 is formed with cap-side second positioners 176 for positioning the Hall elements 152 of the three phases in the direction D12 about the axis with respect to the coil cap 17. The cap-side second positioner 176 is a portion to be fitted in a later-described board-side positioner 154 of the circuit board 15. Three cap-side second positioners 176 are provided so as to be fitted in three board-side positioners 154 of the circuit board 15 in one-to-one correspondence. Each cap-side second positioner 176 is a rectangular piece protruding in the axial direction D11 from the peripheral wall edge 174a of the board-side peripheral wall 174 of the coil cap 17.

The circuit board 15 is formed with the board-side positioners 154 in which the cap-side second positioners 176 of the coil cap 17 are to be fitted. One board-side positioner 154 is provided for each phase according to the arrangement of the Hall elements 152 of the three phases. The board-side positioners 154 are provided at positions in one-to-one correspondence with the Hall elements 152 of the three phases in the direction D12 about the axis, specifically positions each adjacent to the Hall elements 152. Each board-side positioner 154 is a rectangular recessed cutout provided in the outer peripheral edge 15d of the circuit board 15. The cap-side second positioners 176 of the coil cap 17 are fitted in the board-side positioners 154 of the circuit board 15, and in this manner, the Hall elements 152 of the three phases are positioned in the direction D12 about the axis with respect to the coil cap 17.

In the coil cap 17, a relative positional relationship in the direction D12 about the axis between the cap-side first positioners 175 and the cap-side second positioners 176 is the following positional relationship. That is, the positional relationship between the cap-side first positioners 175 and the cap-side second positioners 176 is such a positional relationship that the Hall elements 152 of the three phases are positioned at preset positions in the direction D12 about the axis relative to the stator coils 161 of the three phases. In the present embodiment, the positional relationship between the cap-side first positioners 175 and the cap-side second positioners 176 is such a positional relationship that the Hall elements 152 of the three phases are positioned such that the Hall elements 152 are in one-to-one correspondence with the portions between the stator coils 161 of the three phases.

As described above, the three coil-side positioners 162d of the coil cover 162 are in one-to-one correspondence with the portions between the stator coils 161 of the three phases. Moreover, the three board-side positioners 154 of the circuit board 15 are in one-to-one correspondence with the Hall elements 152 of the three phases. Further, the three cap-side first positioners 175 and the three cap-side second positioners 176 are provided at the positions in one-to-one correspondence with each other in the direction D12 about the axis, specifically the positions adjacent to each other in one-to-one correspondence. With this configuration, when the coil-side positioners 162d are fitted in the cap-side first positioners 175 and the cap-side second positioners 176 are fitted in the board-side positioners 154, the centers of the stator coils 161 and the Hall elements 152 are in one-to-one correspondence with each other.

In the present embodiment, the cap-side first positioners 175 and the board-side positioners 154 as the recessed cutouts for positioning the Hall elements 152 with respect to the stator coils 161 are used for routing the coil electric wires 161a from each stator coil 161.

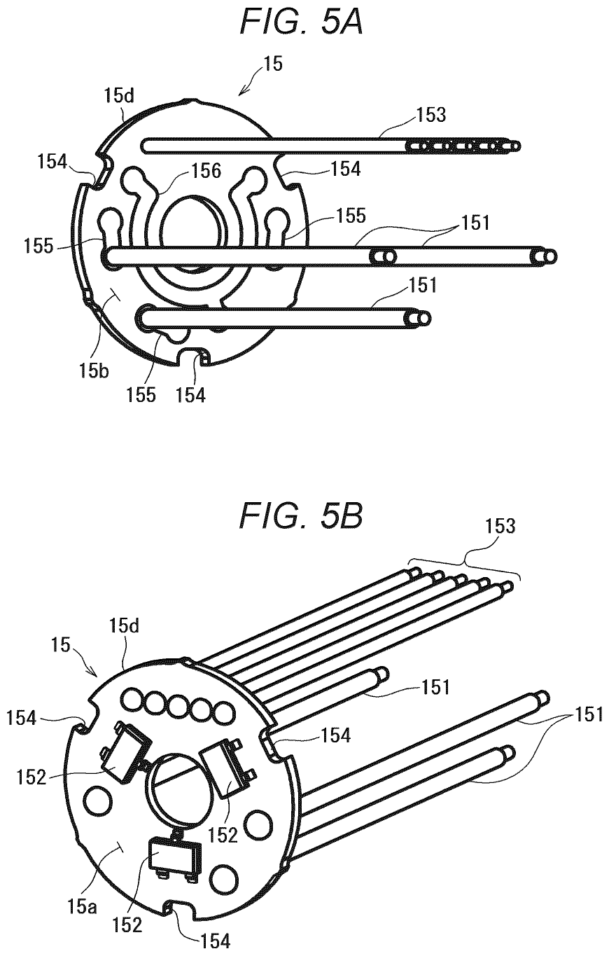

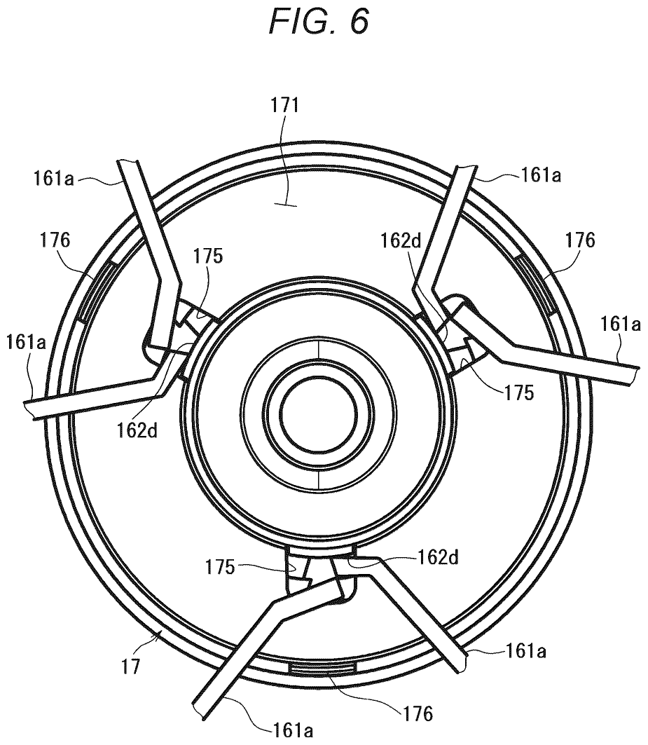

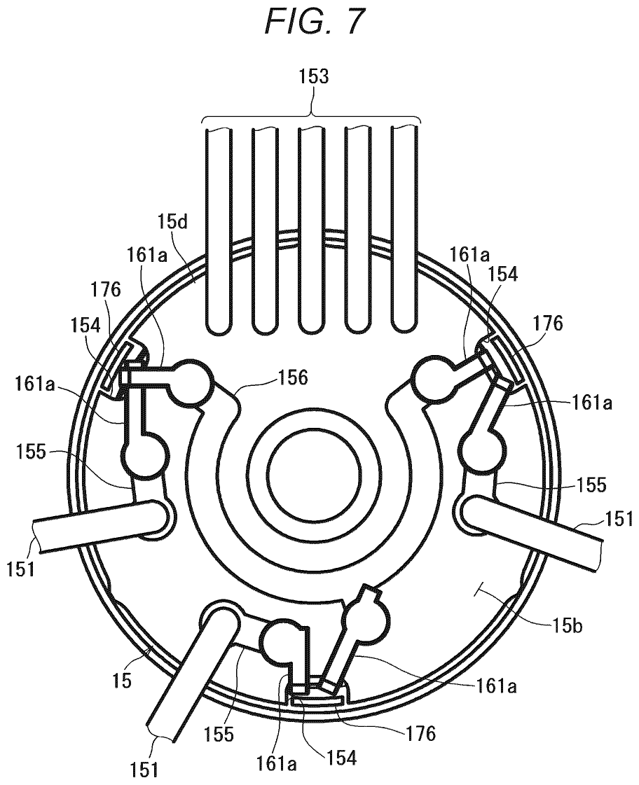

FIGS. 5A and 5B are perspective views of the circuit board of FIGS. 1 and 4 from the mount surface side for mounting the Hall elements and the back of such a mount surface. FIG. 5A shows the perspective view from the back surface 15b. FIG. 5B shows the perspective view from the mount surface 15a for mounting the Hall elements 152. FIG. 6 is a view showing the routing of the coil electric wires from the stator coils without the circuit board. FIG. 7 is a view showing the routing of the coil electric wires from the stator coils from the back of the mount surface, which is for mounting the Hall elements, of the circuit board.

As described with reference to FIG. 1, the motor electric wires 151 of the three phases which are the U-phase, the V-phase, and the W-phase and the five Hall element electric wires 153 are connected to the circuit board 15. The coil electric wire 161a for the power distribution out of the two coil electric wires 161a for the power distribution and the neutral point from each of the stator coils 161 of the three-phase is connected to the motor electric wire 151. An electric wire connection pattern 155 for connecting the coil electric wire 161a for the power distribution to the motor electric wire 151 is formed on the back surface 15b of the mount surface 15a, which is for the mounting the Hall elements 152, of the circuit board 15. The coil electric wire 161a for the neutral point is connected to a neutral point pattern 156 formed common to the three phases on the back surface 15b. For connecting the coil electric wires 161a to the electric wire connection pattern 155 and the neutral point pattern 156, the coil electric wires 161a from each stator coil 161 are routed to the back surface 15b side of the circuit board 15 as shown in FIGS. 6 and 7.

First, as shown in FIG. 6, the two coil electric wires 161a for each phase are routed to the circuit board 15 side through a corresponding one of the three cap-side first positioners 175 provided as the recessed cutouts in the bottom wall 171 of the coil cap 17. At this time, since the coil-side positioners 162d of the coil cover 162 are fitted in the cap-side first positioners 175, the coil electric wires 161a pass through a gap between the inner peripheral edge of the cap-side first positioner 175 and the coil-side positioner 162d.

The two coil electric wires 161a for each phase, which have passed through the cap-side first positioner 175 as described above, subsequently pass through a corresponding one of the three board-side positioners 154 provided as the recessed cutouts in the outer peripheral edge 15d of the circuit board 15, as shown in FIG. 7. At this time, since the cap-side second positioners 176 of the coil cap 17 are fitted in the board-side positioners 154, the coil electric wires 161a pass through a gap between the inner peripheral edge of the board-side positioner 154 and the cap-side second positioner 176. The coil electric wires 161a for each phase reach the back surface 15b side of the circuit board 15 through the board-side positioner 154 as described above. Then, the coil electric wire 161a for the power distribution for each phase is connected to the electric wire connection pattern 155 for each phase on the back surface 15b, and in this manner, is connected to the motor electric wire 151 for each phase. Moreover, the coil electric wire 161a for the neutral point for each phase is connected to the neutral point pattern 156 common to the three phases.

According to the brushless motor 1 of the embodiment described above, the coil-side positioners 162d are fitted in the cap-side first positioners 175, and in this manner, the coil cap 17 is positioned with respect to the stator coils 161 of the three phases. Moreover, the cap-side second positioners 176 are fitted in the board-side positioners 154, and in this manner, the Hall elements 152 of the three phases are positioned with respect to the coil cap 17. Further, the cap-side first positioners 175 and the cap-side second positioners 176 are formed in such a positional relationship that the Hall elements 152 of the three phases are positioned at the preset positions relative to the stator coils 161 of the three phases. As described above, in the brushless motor 1, the Hall elements 152 of the three phases are positioned at the preset positions relative to the stator coils 161 of the three phases only by two fitting processes. Moreover, in the present embodiment, these relative positions are set to positions optimal for determining timing of reversing the polarity in the stator coils 161. That is, according to the above-described brushless motor 1, a burden on a worker can be reduced while the Hall elements 152 are disposed at the positions optimal for determining the timing of reversing the polarity in the stator coils 161.

Here, in the present embodiment, one coil-side positioner 162d and one cap-side first positioner 175 are provided for each phase according to the arrangement of the stator coils 161 of the three phases. Moreover, one board-side positioner 154 and one cap-side second positioner 176 are provided for each phase according to the arrangement of the Hall elements 152 of the three phases. With this configuration, the worker can perform the fitting process while visually checking a state of the Hall elements 152 of the three phases being positioned with respect to the stator coils 161 of the three phases.

In the present embodiment, the three coil-side positioners 162d are provided at the positions in one-to-one correspondence with the portions between the stator coils 161 of the three phases. Moreover, the three board-side positioners 154 are provided at the positions in one-to-one correspondence with the Hall elements 152 of the three phases. Further, the three cap-side first positioners 175 and the three cap-side second positioners 176 are provided at the positions in one-to-one correspondence with each other. The position of the Hall element 152 optimal for determining the timing of reversing the polarity in the stator coil 161 is, for example, a position corresponding to the center of the stator coil 161 in the direction D12 about the axis and a position corresponding to a boundary between the stator coils 161. According to the above-described configuration, the Hall elements 152 can be disposed at the optimal positions.

In the present embodiment, the coil cap 17 has the great-diameter bottomed cylindrical shape with the cap center through-hole 172. The circuit board 15 is the great-diameter circular board, and is held in a state of being mounted on the peripheral wall edge 174a of the coil cap 17. The coil-side positioner 162d is the piece protruding from the cover edge 162c. The cap-side first positioner 175 is the recessed cutout provided in the inner peripheral edge of the cap center through-hole 172. The cap-side second positioner 176 is the piece protruding from the peripheral wall edge 174a. The board-side positioner 154 is the recessed cutout provided in the outer peripheral edge 15d of the circuit board 15. According to this configuration, the location of fitting between the coil-side positioner 162d and the cap-side first positioner 175 and the location of fitting between the cap-side second positioner 176 and the board-side positioner 154 are shifted from each other in a radial direction. With this configuration, interference between these locations of fitting can be avoided, and therefore, the worker can perform the fitting process with favorable workability.

In the present embodiment, the coil electric wires 161a extending from each of the stator coils 161 of the three phases reach the back surface 15b side of the circuit board 15 through the cap-side first positioner 175 and the board-side positioner 154, and are connected to the back surface 15b. According to this configuration, the cap-side first positioner 175 and the board-side positioner 154 as the recessed cutouts also serve as the routing path of the coil electric wires 161a. With this configuration, the shapes of the coil cap 17 and the circuit board 15 can be simplified as compared to a case where a routing path different from the above-described positioners is formed, or the like.

In the present embodiment, each of the stator coils 161 of the three phases is the α-winding coil. According to the α-winding coil, the coil electric wires 161a can extend from the coil outer peripheral side without overlapping with the coil. According to the above-described configuration, as compared to coils of other winding types configured such that the coil electric wires 161a extend from the coil inner peripheral side while overlapping with the coil, the coil electric wires 161a can extend with a less dimension of the stator coil 161 in the thickness direction thereof. The coil electric wire 161a may be a rectangular wire other than a general round wire. Use of the rectangular wire can increase the space factor of each stator coil 161. The coil electric wire 161a may be configured such that a plurality of rectangular wires is stacked in parallel. In this case, the parallel-winding stator coil 161 is formed of the plurality of rectangular wires such that the thickness of the coil is reduced without changing the width of the rectangular wire, so that an eddy current can be reduced. Particularly, the small inner rotor magnet type brushless motor rotatable at a high speed, such as the brushless motor 1, greatly exhibits such an effect. That is, the eddy current generated on the coil at the time of the high-speed rotation can be reduced, and therefore, degradation of motor performance due to heat generation can be reduced.

Note that the embodiment described above is merely the representative form of the brushless motor and the aspects of the present disclosure are not limited to this embodiment. That is, various modifications can be made to the brushless motor for implementation thereof.

For example, in the above-described embodiment, the brushless motor 1 described as one example of the brushless motor includes the rotor magnet 14 with the two poles, the stator coils 161 of the three phases, and the Hall elements 152 of the three phases. However, the brushless motor is not limited thereto. A specific number of poles of the rotor magnet and a specific number of phases for the stator coils and the Hall elements may be set to arbitrary numbers.

In the above-described embodiment, the following brushless motor 1 has been described as one example of the brushless motor. That is, in the brushless motor 1, one coil-side positioner 162d, one cap-side first positioner 175, one board-side positioner 154, and one cap-side second positioner 176 are provided for each phase. However, the brushless motor is not limited thereto. As long as the corresponding positioners can be fitted in each other, a specific number of positioners may be set to an arbitrary number regardless of the number of phases. Note that as described above, one positioner is provided for each of the three phases, so that the worker can perform the fitting process while visually checking a state of the Hall elements 152 of the three phases being positioned with respect to the stator coils 161 of the three phases.

In the above-described embodiment, in the brushless motor 1 described as one example of the brushless motor, the Hall elements 152 of the three phases are positioned at the positions in one-to-one correspondence with the centers of the stator coils 161 of the three phases. The positions of the coil-side positioners 162d, the cap-side first positioners 175, the board-side positioners 154, and the cap-side second positioners 176 in the brushless motor 1 are such positions that the Hall elements 152 can be positioned as described above. However, the brushless motor is not limited thereto. The position of each positioner may be set as necessary. Note that as described above, by positioning each Hall element 152 at the position corresponding to the center of the stator coil 161, the accuracy of positioning the Hall element 152 at the optimal position by the fitting process can be improved. Note that the position of the Hall element 152 optimal for determining the timing of reversing the polarity in the stator coil 161 also includes the boundary between the stator coils 161. Thus, the position of each positioner described above may be set such that each Hall element 152 is positioned at the coil boundary.

In the above-described embodiment, the following brushless motor 1 has been described as one example of the brushless motor. That is, in the brushless motor 1, the location of fitting between the coil-side positioner 162d and the cap-side first positioner 175 and the location of fitting between the cap-side second positioner 176 and the board-side positioner 154 are shifted from each other in the radial direction. Moreover, in the brushless motor 1, the coil-side positioner 162d and the cap-side second positioner 176 are the protruding pieces, and the cap-side first positioner 175 and the board-side positioner 154 are the recessed cutouts. However, each fitting location of the above-described positioner and the shape of each positioner may be set as necessary as long as the fitting is not interfered. Note that as described above, according to the above-described configuration in which the locations of fitting between the positioners are shifted from each other in the radial direction and the fitting is performed using the protruding pieces and the recessed cutouts, such interference between the locations of fitting can be avoided, and therefore, the worker can perform the fitting process with favorable workability.

In the above-described embodiment, in the brushless motor 1 described as one example of the brushless motor, the coil electric wires 161a reach the back surface 15b side of the circuit board 15 through the cap-side first positioner 175 and the board-side positioner 154, and are connected to the back surface 15b. However, the brushless motor is not limited thereto. A coil electric wire routing path different from the cap-side first positioner and the board-side positioner may be provided. Note that as described above, the cap-side first positioner 175 and the board-side positioner 154 as the recessed cutouts also serve as the routing path of the coil electric wires 161a, and therefore, the shapes of the coil cap 17 and the circuit board 15 can be simplified.

In the above-described embodiment, in the brushless motor 1 described as one example of the brushless motor, each of the stator coils 161 of the three phases is the α-winding coil. However, the brushless motor is not limited thereto. An arbitrary winding type can be employed as a specific winding type of the stator coil. Note that as described above, the α-winding coil is employed so that the coil electric wires 161a can extend with a less dimension of the stator coil 161 in the thickness direction thereof.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A brushless motor comprising:
a shaft;
a rotor magnet coupled to the shaft;
stator coils of a plurality of phases arranged so as to surround the rotor magnet about an axis and rotating the rotor magnet;
a coil cover formed in a cylindrical shape housing the rotor magnet therein and holding the stator coils of the plurality of phases on an outer peripheral side;
a circuit board disposed on one end side of the coil cover and configured to detect rotation of the rotor magnet by Hall elements of a plurality of phases mounted and arranged about the axis; and
a coil cap disposed between a board-side cover edge of the coil cover and the circuit board and holding the circuit board,
wherein the cover edge is formed with a coil-side positioner for positioning the coil cap about the axis with respect to the stator coils of the plurality of phases,
the coil cap is formed with a cap-side first positioner in which the coil-side positioner is to be fitted,
the coil cap is formed with a cap-side second positioner for positioning the Hall elements of the plurality of phases about the axis with respect to the coil cap,
the circuit board is formed with a board-side positioner in which the cap-side second positioner is to be fitted, and
a relative positional relationship about the axis between the cap-side first positioner and the cap-side second positioner is such a positional relationship that the Hall elements of the plurality of phases are positioned at preset positions about the axis relative to the stator coils of the plurality of phases.

2. The brushless motor according to claim 1, wherein
the coil-side positioner includes one coil-side positioner for each phase according to arrangement of the stator coils of the plurality of phases,
the cap-side first positioner includes cap-side first positioners fitted in one-to-one correspondence with the plurality of coil-side positioners,
the board-side positioner includes one board-side positioner for each phase according to arrangement of the Hall elements of the plurality of phases, and
the cap-side second positioner includes cap-side second positioners fitted in one-to-one correspondence with the plurality of board-side positioners.

3. The brushless motor according to claim 2, wherein
the plurality of coil-side positioners is provided about the axis at positions in one-to-one correspondence with centers of the stator coils of the plurality of phases or positions in one-to-one correspondence with boundaries between the stator coils of the plurality of phases,
the plurality of board-side positioners is provided about the axis at positions in one-to-one correspondence with the Hall elements of the plurality of phases, and
the plurality of cap-side first positioners and the plurality of cap-side second positioners are provided about the axis in one-to-one correspondence with each other.

4. The brushless motor according to claim 1, wherein
the coil cap has a bottomed cylindrical shape with a greater diameter than that of the cover edge, and at a center of a bottom wall thereof, is provided with a cap center through-hole through which the shaft penetrates,
the circuit board is a circular board having a greater diameter than a board-side inner diameter of the coil cap, and is held in a state of being mounted on a peripheral wall edge of the coil cap,
the coil-side positioner is a piece protruding in an axial direction from the cover edge,
the cap-side first positioner is a recessed cutout provided in an inner peripheral edge of the cap center through-hole such that the coil-side positioner is fitted therein,
the cap-side second positioner is a piece protruding in the axial direction from the peripheral wall edge, and
the board-side positioner is a recessed cutout provided in an outer peripheral edge of the circuit board such that the cap-side second positioner is fitted therein.

5. The brushless motor according to claim 4, wherein
a surface of the circuit board facing the coil cap is a mount surface for mounting the Hall elements of the plurality of phases, and
a coil electric wire extending from each of the stator coils of the plurality of phases reaches a back surface side of the mount surface of the circuit board through the cap-side first positioner and the board-side positioner as the recessed cutouts, and is connected to a back surface of the mount surface.

6. The brushless motor according to claim 1, wherein
each of the stator coils of the plurality of phases is an α-winding coil.
